(19) United States
(12) Patent Application Publication
(10) Pub. No.: US 2026/0045413 A1
(43) Pub. Date: Feb. 12, 2026

(54) CAPACITOR, ELECTRIC CIRCUIT, CIRCUIT BOARD, AND DEVICE

(71) Applicant: Panasonic Intellectual Property Management Co., Ltd., Osaka (JP)

(72) Inventors: TOMOYASU YOKOYAMA, Osaka (JP); RYOSUKE KIKUCHI, Osaka (JP)

(21) Appl. No.: 19/366,587

(22) Filed: Oct. 23, 2025

Related U.S. Application Data
(63) Continuation of application No. PCT/JP2024/013889, filed on Apr. 4, 2024.

(30) Foreign Application Priority Data
May 12, 2023 (JP) 2023-079639

(51) Int. Cl. H01G 4/12; C01G 21/00; C07F 7/24

(52) U.S. Cl. CPC H01G 4/1209; C01G 21/006; C07F 7/24; C01P 2002/72; C01P 2002/77; C01P 2006/40

(57) ABSTRACT

A capacitor includes a first electrode, a second electrode, and a dielectric. The dielectric is disposed between the first electrode and the second electrode. The dielectric includes a crystal having a composition represented by APb₂X₅, where A is a cation which is a molecular ion containing at least one nitrogen atom and X is a halogen element.

### BACKGROUND

### 1. Technical Field

The present disclosure relates to a capacitor, an electric circuit, a circuit board, and a device.

### 2. Description of the Related Art

Halides are conventionally used in devices such as perovskite solar cells.

Japanese Unexamined Patent Application Publication No. 2016-171152, for example, describes a ferroelectric memory element including a pair of electrodes, and a ferroelectric layer sandwiched between the electrodes. The ferroelectric layer comprises a particular halide-based organic-inorganic hybrid perovskite compound or a particular halide-based inorganic perovskite compound. CH₃NH₃PbI₃, C₂H₅NH₃PbI₄, CH₃NH₃SnI₃, C₂H₅NH₃SnI₄, etc. are described in the patent document as examples of the halide-based organic-inorganic hybrid perovskite compound, and CsSnI₃, etc. are described as examples of the halide-based inorganic perovskite compound.

### SUMMARY

In one general aspect, the techniques disclosed here feature a capacitor comprising: a first electrode; a second electrode; and a dielectric disposed between the first electrode and the second electrode. The dielectric comprises a crystal having a composition represented by APb₂X₅, where A is a cation which is a molecular ion containing at least one nitrogen atom and X is a halogen element.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view showing an example of a capacitor of the present disclosure;

FIG. 2A is a diagram showing the crystal structure of CsPb₂Br₅;

FIG. 2B is a diagram showing the crystal structure of (NH₄)Pb₂Br₅;

FIG. 3A is a diagram showing the crystal structure of CsPbBr₃;

FIG. 3B is a diagram showing the crystal structure of CsPbBr₃;

FIG. 4A is a diagram showing the crystal structure of CsPb₂Br₅;

FIG. 4B is a diagram showing the crystal structure of CsPb₂Br₅;

FIG. 4C is a diagram showing the crystal structure of CsPb₂Br₅;

FIG. 5A is a cross-sectional view showing another example of a capacitor of the present disclosure;

FIG. 5B is a cross-sectional view showing yet another example of a capacitor of the present disclosure;

FIG. 5C is a cross-sectional view showing yet another example of a capacitor of the present disclosure;

FIG. 6A is a diagram schematically showing an example of an electric circuit of the present disclosure;

FIG. 6B is a diagram schematically showing an example of a circuit board of the present disclosure;

FIG. 6C is a diagram schematically showing an example of a device of the present disclosure;

FIG. 7 is a graph showing the XRD pattern of a dielectric material included in the capacitor of Example 1;

FIG. 8 is a graph showing the relationship between polarization and electric field strength in the capacitor of Example 1;

FIG. 9 is a graph showing the relationship between polarization and electric field strength in the capacitor of Comparative Example 1; and

FIG. 10 is a graph showing the relationship between polarization and electric field strength in the capacitor of Comparative Example 2.

### DETAILED DESCRIPTIONS

### Findings Underlying the Present Disclosure

In recent years, as electronic devices have become smaller and more sophisticated, electronic circuits have become smaller and more highly integrated, and have come to operate at higher frequencies. Therefore, downsizing and improvements in performance are required for electronic components for use in electronic circuits. For example, if a small capacitor having a high capacitance can be provided, it will contribute to the downsizing and improvements in performance of electronic components. The capacitance of a capacitor depends on the relative dielectric constant of a dielectric used in the capacitor; the higher the relative dielectric constant, the higher the capacitance. Capacitors using an oxide dielectric, which exhibits a high relative dielectric constant, have been widely developed. However, the synthesis of such an oxide often requires a heat treatment at a temperature as high as 500° C. or more, resulting in a high manufacturing cost of a capacitor. Further, an oxide often has a small elastic constant, which makes it difficult to increase the filling rate of a pressed powder product. Therefore, it is difficult to enhance the performance of a capacitor. In addition, an oxide is unlikely to have high strength against bending stress.

A halide has the potential to eliminate the disadvantages of such an oxide. A halide is generally highly soluble in water and an organic solvent, and therefore can be easily synthesized by a coating method. In addition, a halide can be synthesized at a temperature as low as 200° C. or less. Therefore, a reduction in the manufacturing cost of a capacitor can be expected. Further, a halide film can be formed even on a substrate like a film whose high-temperature endurance is not high. Therefore, the realization of a flexible capacitor can be expected. On the other hand, according to a study by the present inventors, conventional halide dielectrics, which are composed of inorganic elements, have low solubility in solvents. Therefore, when a coating film comprising a halide dielectric is formed by a coating method such as spin coating, the film is likely to be non-uniform. The non-uniformity of the film can cause leakage current under an electric field. Thus, it has been found that coating films comprising a conventional halide dielectric have the problem that it is difficult to increase the withstand voltage.

In view of such a situation, the present inventors have intensively studied whether it is possible to increase the withstand voltage of a film comprising a halide by allowing a molecular ion to exist as part of a cation in the halide. As a result, the inventors have newly found that a halide containing a cation, which is a particular molecular ion, and lead is likely to have a high withstand voltage. Based on this finding, the inventors have devised a capacitor of the present disclosure.

According to the present disclosure, it is possible to provide a capacitor which is advantageous in terms of high withstand voltage.

### EMBODIMENTS

Embodiments of the present disclosure will now be described with reference to the drawings. The present disclosure is not limited to the following embodiments.

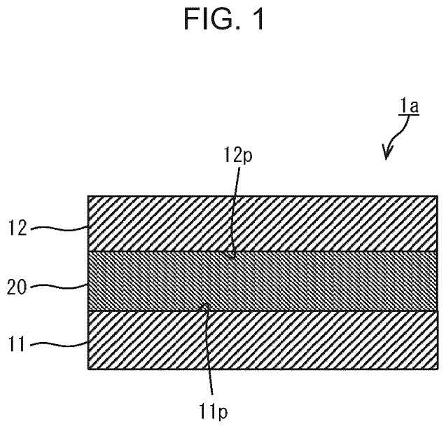

FIG. 1 is a cross-sectional view showing an example of a capacitor of the present disclosure. As shown in FIG. 1, the capacitor 1a includes a first electrode 11, a second electrode 12, and a dielectric 20. The dielectric 20 is disposed between the first electrode 11 and the second electrode 12. The dielectric 20 comprises a crystal having the composition APb₂X₅, where A is a cation which is a molecular ion containing at least one nitrogen atom and X is a halogen element. The molecular ion may contain two or more nitrogen atoms.

The cation A is likely to have high solubility in a solvent. Therefore, the dielectric 20 is likely to exist in a uniform state between the first electrode 11 and the second electrode 12, and the capacitor 1a is likely to have a high withstand voltage.

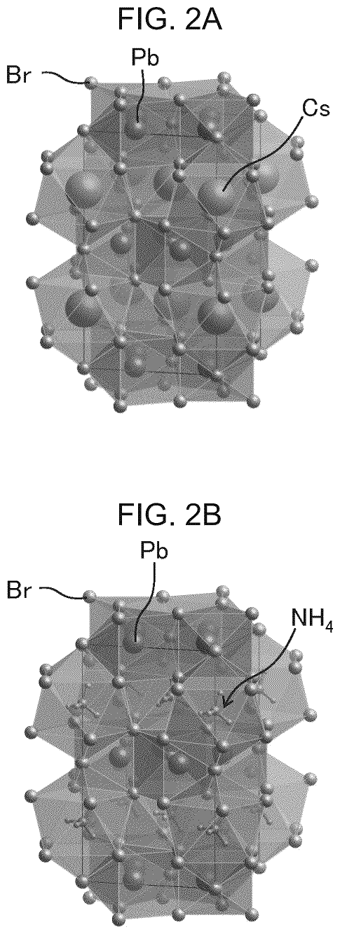

FIG. 2A is a diagram showing the crystal structure of CsPb₂Br₅. FIG. 2B is a diagram showing the crystal structure of (NH₄)Pb₂Br₅. CsPb₂Br₅ is composed of inorganic ions which are Cs⁺, Pb²⁺, and Br⁻. On the other hand, (NH₄)Pb₂Br₅ has a structure in which Cs⁺ in CsPb₂Br₅ is replaced with an NH₄⁺ cation. A raw material for a halide containing no molecular ion, such as CsPb₂Br₅, is likely to have low solubility in a solvent. For example, when 0.5 millimoles (mmol) of CsBr and 1 mmol of PbBr₂ are added to a 1 ml of a mixed solvent of dimethyl sulfoxide (DMSO) and N,N-dimethylformamide (DMF), and heated at 80 degrees for 1 hour, the raw material remains undissolved and does not dissolve completely, resulting in a cloudy solution. Therefore, if a film is formed using this solution by a coating method such as spin coating, the film will be a non-uniform film. The non-uniformity of the film can cause leakage current under an electric field. The formation of the non-uniform film is considered to be due to the low solubility of CsBr in the solvent. On the other hand, NH₄Br, which contains the molecular ion containing a nitrogen atom, dissolves instantly in the solvent. When NH₄Br is added to the solvent at the same molar concentration as that of CsBr in the solution containing CsBr, a colorless and transparent solution will be obtained. Thus, when A in the dielectric 20 of the capacitor 1a is a molecular ion containing a nitrogen atom(s), the dielectric 20 is likely to exist in a uniform state, and the capacitor 1a is likely to have a high withstand voltage.

The cation A in the above composition may have only one or more nitrogen atoms and one or more hydrogen atoms, or may further contain one or more carbon atoms.

The cation A in the above composition is, for example, an ammonium ion represented by the following formula (I). In formula (I), R¹, R², R³, and R⁴ are each independently a hydrogen atom, an alkyl group, an aryl group, or NH₂. In this case, the cation A, which is a molecular ion, is likely to have high solubility in a solvent, and the capacitor 1a is more likely to have a high withstand voltage.

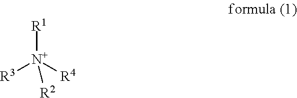

In formula (I), R¹ and R² may each independently be a hydrogen atom, an alkyl group, or an aryl group, and R³ and R⁴ may each be a hydrogen atom. In this case, the cation A, which is a molecular ion, is likely to have high solubility in a solvent, and the capacitor 1a is more likely to have a high withstand voltage.

In formula (I), R¹, R², R³, and R⁴ may each be a hydrogen atom. In this case, the cation A, which is a molecular ion, is likely to have high solubility in a solvent, and the capacitor 1a is more likely to have a high withstand voltage.

In formula (I), R¹, for example, may be NH₂, and R², R³, and R⁴ may each be a hydrogen atom. In this case, the cation A, which is a molecular ion, is likely to have high solubility in a solvent, and the capacitor 1a is more likely to have a high withstand voltage.

When the cation A in the above composition is an ammonium ion represented by the above formula (I), and R¹, R², R³, or R⁴ is an alkyl group, the alkyl group is not particularly limited. The number of carbon atoms in the alkyl group is, for example, 1 to 20. At least one hydrogen atom in the alkyl group may be substituted or unsubstituted.

The alkyl group may be a saturated radical having a straight or branched chain. At least one hydrogen atom in the saturated radical may be substituted or unsubstituted. The alkyl group is, for example, a saturated hydrocarbon radical having 1 to 20 carbon atoms and having a straight or branched chain. At least one hydrogen atom in the saturated hydrocarbon radical may be substituted or unsubstituted. The alkyl group may be an alkyl group having 1 to 20 carbon atoms. Examples of such an alkyl group include a methyl group, an ethyl group, a propyl group, a butyl group, a pentyl group, a hexyl group, a heptyl group, an octyl group, a nonyl group, and a decyl group. The alkyl group may be an alkyl group having 1 to 6 carbon atoms. Examples of such an alkyl group include a methyl group, an ethyl group, a propyl group, a butyl group, a pentyl group, and a hexyl group. The alkyl group may be an alkyl group having 1 to 4 carbon atoms. Examples of such an alkyl group include a methyl group, an ethyl group, an i-propyl group, an n-propyl group, a t-butyl group, an s-butyl group, an n-butyl group, and a pentyl group.

When at least one hydrogen atom in the alkyl group is substituted by a substituent, the substituent may include, for example, one or more substituents selected from the group consisting of an alkyl group, an aryl group, a cyano group, and an amino group. The alkyl group as the substituent may have 1 to 20 carbon atoms. At least one hydrogen atom in the alkyl group as the substituent may be substituted or unsubstituted. At least one hydrogen atom in the aryl group may be substituted or unsubstituted. Examples of the substituent include an alkylamino group, a dialkylamino group, an arylamino group, a diarylamino group, an arylalkylamino group, an amido group, an acylamido group, a hydroxy group, an oxo group, a halo group, a carboxy group, an ester group, an acyl group, an acyloxy group, an alkoxy group, an aryloxy group, a haloalkyl group, a sulfonic acid group, a sulfhydryl group, an alkylthio group, an arylthio group, a sulfonyl group, a phosphoric acid group, a phosphoric acid ester group, a phosphonic acid group, and a phosphonic acid ester group. Examples of substituted alkyl groups include a haloalkyl group, a hydroxyalkyl group, an aminoalkyl group, an alkoxyalkyl group, and an alkaryl group. The alkaryl group is, for example, an alkyl group having 1 to 20 carbon atoms, in which at least one hydrogen atom is substituted by an aryl group. The alkaryl group is not particularly limited. Examples of the alkaryl group include a benzyl group, a benzhydryl group, a trityl group, a phenethyl group, a styryl group, and a cinnamyl group.

When the cation A in the above composition is an ammonium ion represented by the above formula (I), and R¹, R², R³, or R⁴ is an aryl group, the aryl group is not particularly limited. The aryl group is, for example, a monocyclic or bicyclic aromatic group. The aryl group has, for example, a ring structure containing 6 to 14 carbon atoms, preferably a ring structure containing 6 to 10 carbon atoms. At least one hydrogen atom in the aryl group may be substituted or unsubstituted. Examples of the aryl group include a phenyl group, a naphthyl group, an indenyl group, and an indanyl group. When the aryl group is substituted, the aryl group has, for example, one or more substituents selected from the group consisting of an unsubstituted alkyl group having 1 to 6 carbon atoms, an unsubstituted aryl group, a cyano group, an amino group, an alkylamino group, a dialkylamino group having 1 to 10 carbon atoms, an arylamino group, a diarylamino group, an arylalkylamino group, an amido group, an acylamido group, a hydroxy group, a halo group, a carboxy group, an ester group, an acyl group, an acyloxy group, an alkoxy group having 1 to 20 carbon atoms, an aryloxy group, a haloalkyl group, a sulfhydryl group, an alkylthio group having 1 to 10 carbon atoms, an arylthio group, a sulfonic acid group, a phosphoric acid group, a phosphoric acid ester group, a phosphonic acid group, a phosphonic acid ester group, and a sulfonyl group. The aryl group may have no substituent, or may have one, two, or three substituents. The substituted aryl group may be substituted at the 2-position with a single alkylene group having 1 to 6 carbon atoms or with a bidentate group represented by —X—R⁹— or —X—R⁹—X—. R⁹ is an alkylene group having 1 to 6 carbon atoms. X is selected from the group consisting of O, S, and NR¹⁰. R¹⁰ is a hydrogen atom, an aryl group, or an alkyl group having 1 to 6 carbon atoms. The substituted aryl group may be an aryl group fused to a cycloalkyl group or an aryl group fused to a heterocyclyl group. The ring atoms of the aryl group may include one or more heteroatoms as in a heteroaryl group. Such a heteroaryl group is a substituted or unsubstituted monocyclic or bicyclic heteroaromatic group containing 6 to 10 atoms in the ring moiety containing one or more heteroatoms. For example, the heteroaryl group is in the form of a five- or six-membered ring and contains at least one heteroatom selected from O, S, N, P, Se, and Si. The heteroaryl group may contain, for example, 1, 2, or 3 heteroatoms. Examples of the heteroaryl group include a pyridyl group, a pyrazinyl group, a pyrimidinyl group, a pyridazinyl group, a furanyl group, a thienyl group, a pyrazolidinyl group, a pyrrolyl group, an oxazolyl group, an oxadiazolyl group, an isoxazolyl group, a thiadiazolyl group, a thiazolyl group, an isothiazolyl group, an imidazolyl group, a pyrazolyl group, a quinolyl group, and an isoquinolyl group. The heteroaryl group may be unsubstituted, or substituted, for example, in the manner described above with reference to the aryl group. The heteroaryl group may have 0, 1, 2, or 3 substituents.

In formula (I), R¹, R², R³, and R⁴ are each independently, for example, a hydrogen atom, NH₂, a methyl group, or an ethyl group. R¹, R², R³, and R⁴ may each independently be a hydrogen atom, NH₂, or a methyl group.

A lead ion in the dielectric 20 may have a lone pair. A lone pair is an electron pair composed of two electrons belonging to a particular atom, which have entered an electron orbital in a pair and which are not shared with another atom. For example, a Pb²⁺ ion has a lone pair. In a Pb²⁺ ion, two electrons have been stripped off Pb, and two electrons that fill the outermost s orbital constitute a lone pair. Electrons constituting a lone pair are unlikely to bind with surrounding ions, and may cause an unstable electronic state or a special crystal structure. Accordingly, when the lead ion in the dielectric 20 has a lone pair, the relative dielectric constant of the dielectric 20 is likely to be high. In addition to the Pb²⁺ ion, a Pb⁴⁺ ion can also exist as a lead ion. In a Pb⁴⁺ ion, four electrons have been stripped off Pb, and the outermost s orbital is empty. Thus, a Pb⁴⁺ ion does not have a lone pair. In this case, a crystal structure with a low coordination number is likely to be formed, and the relative dielectric constant of the material is unlikely to be high.

For example, all the lead ions in the dielectric 20 may have a lone pair, or only some of the lead ions in the dielectric 20 may have a lone pair.

The X in the dielectric 20 comprises, for example, at least one selected from the group consisting of F, Cl, Br, and I. In this case, the dielectric 20 is more likely to have a high relative dielectric constant.

The dielectric 20 has, for example, an anti-perovskite structure. The dielectric 20 having such a structure is more likely to have a high relative dielectric constant.

An anti-perovskite structure is a structure in which the positions of a cation and an anion in a normal perovskite compound are interchanged. In other words, the positive or negative of the charges of an ion occupying a particular site in a perovskite compound is opposite to the positive or negative of the charges of an ion occupying the particular site in a compound having an anti-perovskite structure.

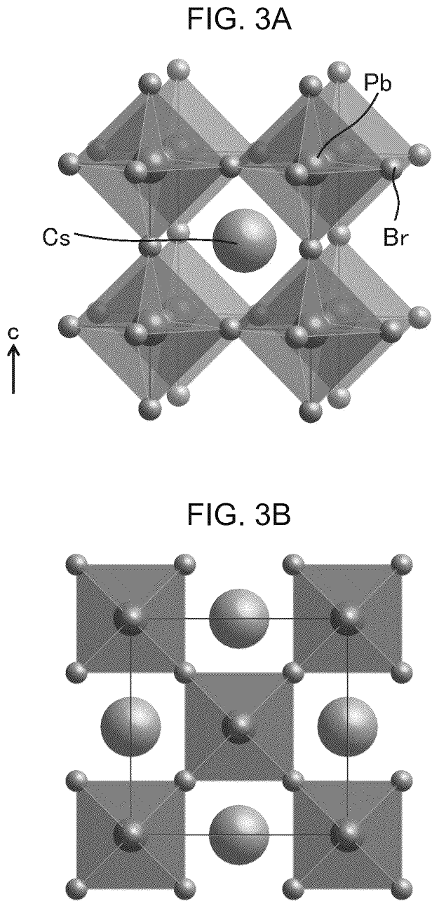

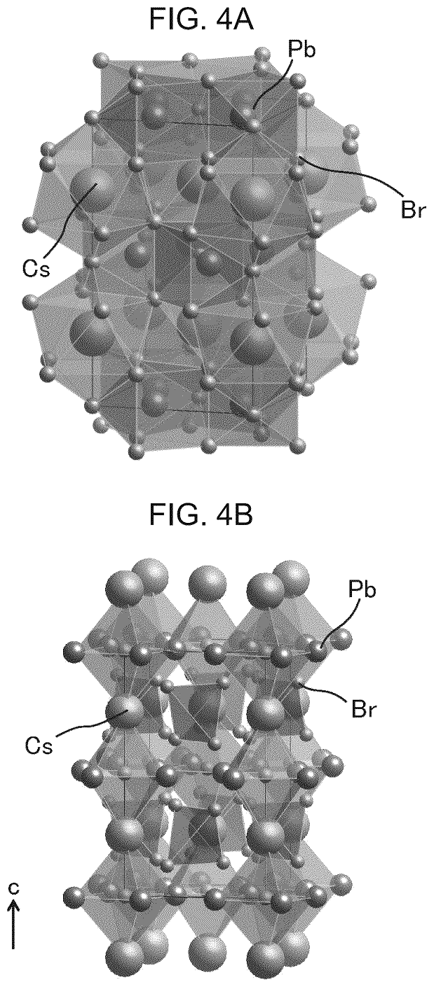

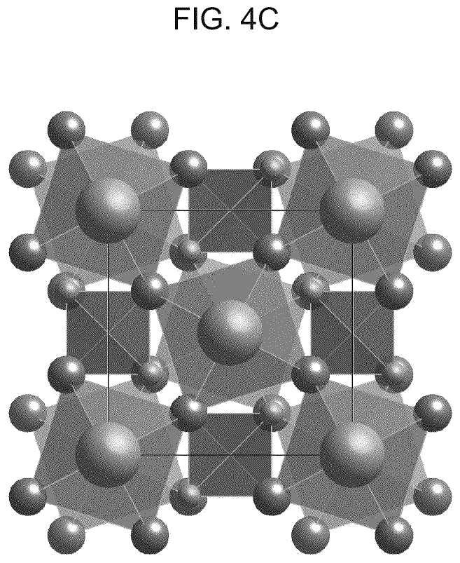

FIGS. 3A and 3B are diagrams showing the crystal structure of CsPbBr₃. FIG. 3B is a diagram showing the crystal structure of FIG. 3A as viewed along a negative direction of a c-axis. CsPbBr₃ has a perovskite structure. FIGS. 4A, 4B, and 4C are diagrams showing the crystal structure of CsPb₂Br₅. FIG. 4B is a diagram showing the crystal structure of CsPb₂Br₅ in terms of anion-centered coordination polyhedra. FIG. 4C is a diagram showing the crystal structure of FIG. 4B as viewed along the negative direction of the c-axis. CsPb₂Br₅ has an anti-perovskite structure. As shown in FIG. 3A, in CsPbBr₃, Cs is located at the A-site of the perovskite structure, Pb is located at the B-site, and Br is located at the X-site. On the other hand, as shown in FIG. 4B, in CsPb₂Br₅, Br₄ are located at a site corresponding to the A-site of the perovskite structure, Br is located at a site corresponding to the B-site, and Cs or Pb is located at a site corresponding to the X-site. In other words, CsPb₂Br₅ is expressed as (Br₄)Br(CsPb₂) in the notation ABX₃.

When the dielectric 20 comprising a crystal having the composition APb₂X₅ has an anti-perovskite structure, for example in the crystal structure shown in FIG. 4B, Cs is replaced with the cation A. In the anti-perovskite structure shown in FIG. 4B, there is a moiety where cations are located at the vertices of octahedrons that share the vertices, and an anion is located at the center of each octahedron. Therefore, ions are likely to line up in a straight line in the anti-perovskite structure, resulting in high polarization. Thus, the dielectric 20 is more likely to have a high relative dielectric constant.

The anti-perovskite structure of the dielectric 20 having the composition APb₂X₅ may be an NH₄Pb₂Br₅-type structure, a Cs₃CoCl₅-type structure, an La₂CuSbS₅-type structure, an La₄FeSb₂S₁₀-type structure, a Ba₄In₂Te₂S₅-type structure, a Y₂HfM₅-type structure, or a TlPb₂Cl₅-type structure.

The relative dielectric constant of the dielectric 20 is not limited to a particular value. The relative dielectric constant of the dielectric 20 at room temperature may be, for example, higher than or equal to 30 at 1 MHz, or higher than or equal to 35, higher than or equal to 40, higher than or equal to 45, higher than or equal to 50, higher than or equal to 60, higher than or equal to 70, higher than or equal to 80, higher than or equal to 90, or higher than or equal to 100. The room temperature is, for example, a particular temperature in the range of 20° C. to 25° C. The relative dielectric constant of the dielectric 20 at room temperature is, for example, lower than or equal to 10,000 at 1 MHz. In other words, the relative dielectric constant of the dielectric 20 at room temperature is, for example, higher than or equal to 30 and lower than or equal to 10,000 at 1 MHz.

As shown in FIG. 1, in the capacitor 1a, the dielectric 20 is formed, for example, in the form of a film. There is no particular limitation on the method for forming the dielectric 20. The dielectric 20 may be formed, for example, by spin coating, inkjet printing, die coating, roll coating, bar coating, the Langmuir-Blodgett method, dip coating, or spray coating. The dielectric 20, formed by such a method, is more likely to exist in a uniform state between the first electrode 11 and the second electrode 12, and the capacitor 1a is more likely to have a high withstand voltage. The dielectric 20 may also be formed by sputtering, anodization, vacuum deposition, pulsed laser deposition (PLD), atomic layer deposition (ALD), or chemical vapor deposition (CVD).

As shown in FIG. 1, the dielectric 20 is disposed, for example, between the first electrode 11 and the second electrode 12 in the thickness direction of the dielectric 20. The second electrode 12 covers, for example, at least part of the dielectric 20.

The material of the first electrode 11 and the material of the second electrode 12 are not particularly limited. The first electrode 11 and the second electrode 12 each comprise, for example, a metal. The first electrode 11 comprises, for example, a valve metal. Examples of the valve metal include Al, Ta, Nb, Pb, Sn, and Bi. The first electrode 11 comprises, for example, at least one valve metal selected from the group consisting of Al, Ta, Nb, Pb, Sn, and Bi. The first electrode 11 may comprise a noble metal such as gold or platinum, may comprise nickel, or may comprise a metal element of Group 13, Group 14, or Group 15.

The second electrode 12 may comprise, for example, a valve metal such as Al, Ta, Nb, Pb, Sn, or Bi, may comprise a noble metal such as gold, silver, or platinum, may comprise nickel, or may comprise a metal element of Group 13, Group 14, or Group 15. The second electrode 12 comprises, for example, at least one selected from the group consisting of Al, Ta, Nb, Bi, gold, silver, platinum, and nickel.

As shown in FIG. 1, the first electrode 11 has a principal surface 11p. One principal surface of the dielectric 20 is, for example, in contact with the principal surface 11p. The second electrode 12 has a principal surface 12p parallel to the principal surface 11p. The other principal surface of the dielectric 20 is, for example, in contact with the principal surface 12p.

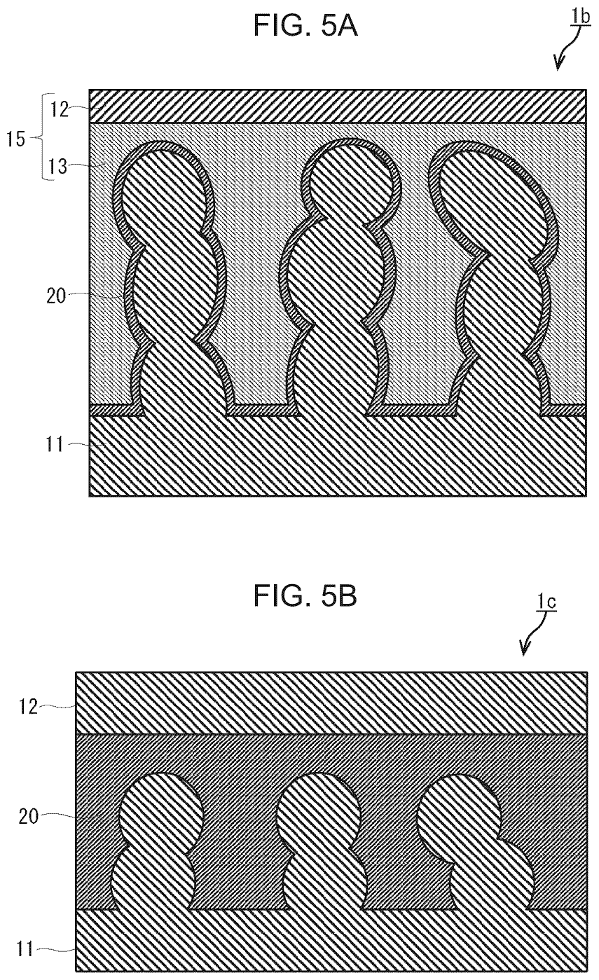

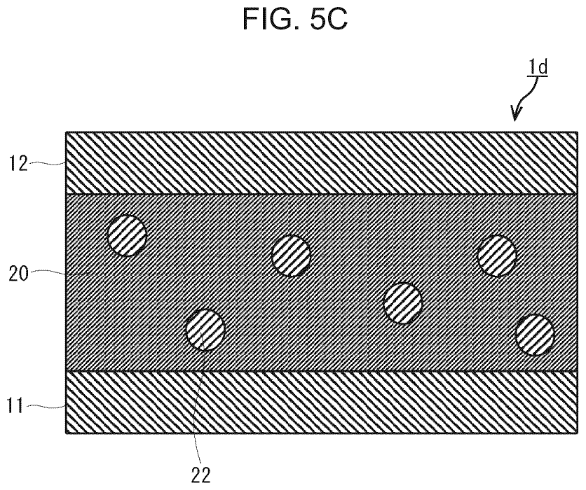

FIG. 5A is a cross-sectional view showing another example of a capacitor of the present disclosure. The capacitor 1b shown in FIG. 5A is configured similarly to the capacitor 1a except for a feature which will be particularly described. The same symbols are used for elements or components of the capacitor 1b which are the same as or equivalent to those of the capacitor 1a, and a detailed description thereof will be omitted. The above description of the capacitor 1a applies also to the capacitor 1b as long as there is no technical contradiction. The same holds true for the below-described capacitors 1c and 1d.

The capacitor 1b shown in FIG. 5A is an electrolytic capacitor. As shown in FIG. 5A, in the capacitor 1b, at least part of the first electrode 11 is porous. With such a feature, the first electrode 11 is likely to have a large surface area, and the capacitor 1b is likely to have a higher capacitance. Such a porous structure can be formed by a method such as etching of a metal foil or sintering of a powder.

As shown in FIG. 5A, a film of dielectric 20 is formed, for example, over the surface of the porous portion of the first electrode 11. Examples of usable methods for forming the dielectric 20 include spin coating, inkjet printing, die coating, roll coating, bar coating, the Langmuir-Blodgett method, dip coating, and spray coating. The dielectric 20 may also be formed, for example, by sputtering, anodization, vacuum deposition, PLD, ALD, or CVD.

The first electrode 11 comprises, for example, a valve metal such as Al, Ta, Nb, Zr, Hf, Pb, Sn, or Bi. The second electrode 12 may comprise, for example, a solidified silver-containing paste or a carbon material such as graphite, or both the solidified paste and the carbon material.

In the capacitor 1b, an electrolyte 13 is disposed, for example, between the first electrode 11 and the second electrode 12. In particular, the electrolyte 13 is disposed between the dielectric 20 and the second electrode 12. In the capacitor 1b, the second electrode 12 and the electrolyte 13, for example, constitute a cathode 15. In the capacitor 1b, the electrolyte 13 is disposed, for example, such that it fills the space around the porous portion of the first electrode 11.

The electrolyte 13 comprises, for example, at least one selected from the group consisting of an electrolytic solution and a conductive polymer. Examples of the conductive polymer include polypyrrole, polythiophene, polyaniline, and derivatives thereof. The electrolyte 13 may comprise a manganese compound such as manganese oxide. The electrolyte 13 may comprise a solid electrolyte.

The electrolyte 13 comprising the conductive polymer can be formed by performing chemical polymerization or electrolytical polymerization, or both chemical polymerization and electrolytical polymerization of a starting monomer(s) on the dielectric 20. The electrolyte 13 comprising the conductive polymer may be formed by attaching a solution or dispersion of the conductive polymer to the dielectric 20.

FIG. 5B is a cross-sectional view showing yet another example of a capacitor of the present disclosure. In the capacitor 1c shown in FIG. 5B, at least part of the first electrode 11 is porous. With such a feature, the first electrode 11 is likely to have a large surface area, and the capacitor 1c is likely to have a higher capacitance. Such a porous structure can be formed by a method such as etching of a metal foil or sintering of a powder.

As shown in FIG. 5B, a film comprising dielectric 20 is formed, for example, over the porous portion of the first electrode 11. Examples of usable methods for forming the film comprising dielectric 20 include spin coating, inkjet printing, die coating, roll coating, bar coating, the Langmuir-Blodgett method, dip coating, and spray coating. In the capacitor 1c, the dielectric 20 is disposed, for example, such that it fills the space around the porous portion of the first electrode 11.

FIG. 5C is a cross-sectional view showing yet another example of a capacitor of the present disclosure. In the capacitor 1d shown in FIG. 5C, the dielectric 20 is formed, for example, in the form of a film. Heterogeneous dielectrics 22, which differ from the dielectric 20, are dispersed or distributed in the film. Examples of usable methods for forming the film include spin coating, inkjet printing, die coating, roll coating, bar coating, the Langmuir-Blodgett method, dip coating, and spray coating. The film comprising the dielectric 20 and the heterogeneous dielectrics 22 can be obtained by forming a coating of a precursor liquid, containing a raw material for the dielectric 20 and particulate heterogeneous dielectrics 22, by the above method. The film may also be formed by sputtering, anodization, vacuum deposition, PLD, ALD, or CVD.

The heterogeneous dielectrics 22 are not particularly limited as long as they are of a type different from the dielectric 20. The heterogeneous dielectrics 22 have, for example, a higher relative dielectric constant than the dielectric 20. The heterogeneous dielectrics 22 may comprise, for example, a perovskite compound such as BaTiO₃, PbTiO₃, or SrTiO₃, or a layered perovskite compound. The heterogeneous dielectrics 22 may comprise at least one selected from the group consisting of a Ruddlesden-Popper compound, a Dion-Jacobson compound, a tungsten bronze compound, and a pyrochlore compound.

The particle size of the heterogeneous dielectrics 22 is not particularly limited. The heterogeneous dielectrics 22 have, for example, a particle size of greater than or equal to 1 nm and less than or equal to 100 nm.

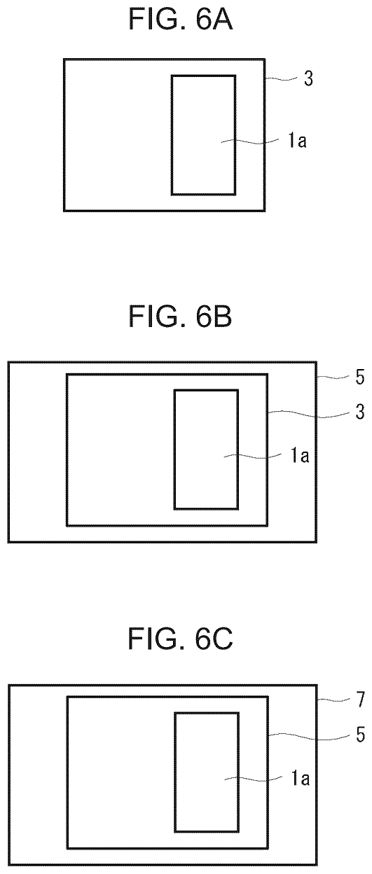

FIG. 6A is a diagram schematically showing an example of an electric circuit of the present disclosure. The electric circuit 3 includes the capacitor 1a. The electric circuit 3 may be an active circuit or a passive circuit. The electric circuit 3 may be a discharge circuit, a smoothing circuit, a decoupling circuit, or a coupling circuit. Since the electric circuit 3 includes the capacitor 1a, the electric circuit 3 is likely to deliver the desired performance. For example, the capacitor 1a is likely to reduce noise in the electric circuit 3. The electric circuit 3 may include the capacitor 1b, 1c, or 1d instead of the capacitor 1a.

FIG. 6B is a diagram schematically showing an example of a circuit board of the present disclosure. As shown in FIG. 6B, the circuit board 5 includes the capacitor 1a. The electric circuit 3 including the capacitor 1a, for example, is formed on the circuit board 5. The circuit board 5 may be an embedded board or a motherboard. The circuit board 5 may include the capacitor 1b, 1c, or 1d instead of the capacitor 1a.

FIG. 6C is a diagram schematically showing an example of a device of the present disclosure. As shown in FIG. 6C, the device 7 includes, for example, the capacitor 1a. The device 7 includes, for example, the circuit board 5 including the capacitor 1a. Since the device 7 includes the capacitor 1a, the device 7 is likely to deliver the desired performance. The device 7 may be an electronic device, a communication device, a signal processing device, or a power supply device. The device 7 may be a server, an AC adapter, an accelerator, or a flat panel display such as a liquid crystal display (LCD). The device 7 may be a USB charger, a solid state drive (SSD), an information terminal such as a PC, a smartphone, or a tablet PC, or an Ethernet switch.

### Additional Description

As described hereinabove, the following technologies are disclosed herein.

### Technology 1

A capacitor comprising:
a first electrode;
a second electrode; and
a dielectric disposed between the first electrode and the second electrode,
wherein the dielectric comprises a crystal having a composition represented by APb₂X₅, where
A is a cation which is a molecular ion containing at least one nitrogen atom, and
X is a halogen element.

### Technology 2

The capacitor according to Technology 1, wherein the cation further contains at least one carbon atom.

### Technology 3

The capacitor according to Technology 1, wherein the cation is an ammonium ion represented by the following formula:

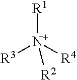

where R¹, R², R³, and R⁴ are each independently a hydrogen atom, an alkyl group, an aryl group, or NH₂.

### Technology 4

The capacitor according to Technology 3, wherein in the formula, R¹ and R² are each independently a hydrogen atom, an alkyl group, or an aryl group, and R³ and R⁴ are each a hydrogen atom.

### Technology 5

The capacitor according to Technology 4, wherein in the formula, R¹, R², R³, and R⁴ are each a hydrogen atom.

### Technology 6

The capacitor according to Technology 3, wherein in the formula, R¹ is NH₂ and R², R³, and R⁴ are each a hydrogen atom.

### Technology 7

The capacitor according to any one of Technologies 1 to 6, wherein the dielectric has an anti-perovskite structure.

### Technology 8

An electric circuit including the capacitor according to any one of Technologies 1 to 7.

### Technology 9

A circuit board including the capacitor according to any one of Technologies 1 to 7.

### Technology 10

A device including the capacitor according to any one of Technologies 1 to 7.

### EXAMPLES

The present disclosure will now be described in more detail with reference to examples. The following examples are provided for illustration purposes, and not intended to limit the scope of the present disclosure.

### Example 1

A glass substrate, manufactured by Nippon Sheet Glass Company, Ltd., was provided which had an indium-doped SnO₂ layer on its surface. The indium-doped SnO₂ layer functioned as an electrode. The glass substrate was ultrasonically cleaned for 10 minutes in a container filled with ethanol to clean the surface of the glass substrate. Thereafter, a UV ozone treatment of the surface of the glass substrate was performed for 30 minutes to remove adsorbed materials from the surface.

Next, 0.5 mmol of NH₄Br and 1 mmol of PbBr₂ were added to 1 ml of a mixed solvent of DMSO and DMF to obtain a mixed solution. The volume ratio DMSO:DMF in the mixed solvent was 1:4. When the solution was heated to 80 degrees Celsius, NH₄Br and PbBr₂ were easily dissolved. Impurities were removed from the solution using a filter to obtain a coating solution according to Example 1. 80 μl of the coating solution of Example 1 was dropped onto the indium-doped SnO₂ layer of the above glass substrate in a glove box, followed by spin coating to obtain a coating film. The interior of the glove box was filled with N₂, and the oxygen concentration was less than or equal to 0.1 ppm (parts per million) on a volume basis. Subsequently, the coating film was heat-treated for 30 minutes on a hot plate maintained at 80 degrees Celsius. In this manner, a dielectric layer was formed. The dielectric layer mainly contained an anti-perovskite compound having the composition NH₄Pb₂Br₅. Finally, gold was vapor-deposited on the dielectric layer to form an electrode. In this manner, a capacitor according to Example 1 was obtained.

### Crystal Structure Analysis

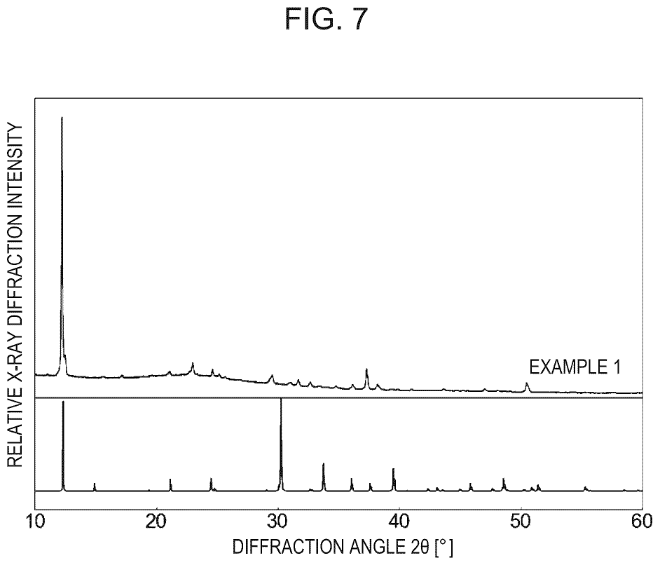

In order to identify the crystal structure of the dielectric material contained in the dielectric layer of the capacitor of Example 1, an X-ray diffraction (XRD) measurement was performed on the dielectric layer. The measurement was performed under a dry argon atmosphere using Cu-Ka rays as X-rays. FIG. 7 is a graph showing the XRD pattern of the dielectric material contained in the dielectric layer of the capacitor of Example 1. In FIG. 7, the abscissa axis represents the diffraction angle 2θ [degrees], and the ordinate axis represents the relative X-ray diffraction intensity. The results of a simulation of the XRD pattern of (NH₄)PbBr₅-type KSn₂Cl₅ having an anti-perovskite structure are also shown at the bottom of FIG. 7. The data in FIG. 7 indicates that the dielectric material contained in the dielectric layer of the capacitor of Example 1 has an anti-perovskite structure.

### Compositional Analysis

Using an X-ray photoelectron spectroscopy (XPS) apparatus PHI VersaProbe 2 manufactured by ULVAC-PHI, Inc., the contents of N, Pb, and Br per unit weight of the dielectric material, contained in the dielectric layer of the capacitor of Example 1, were measured by XPS measurement. Based on the contents of N, Pb, and Br obtained from the results of the XPS measurement, and taking into account the composition estimated from the results of the XRD measurement, the N:Pb:Br molar ratio was calculated. As a result, it was found that in the dielectric material contained in the dielectric layer of the capacitor of Example 1, as with the molar ratio in the raw material, [amount of substance of N:amount of substance of Pb:amount of substance of Br] was equal to 1:2:5.

### Evaluation of Withstand Voltage and Polarization

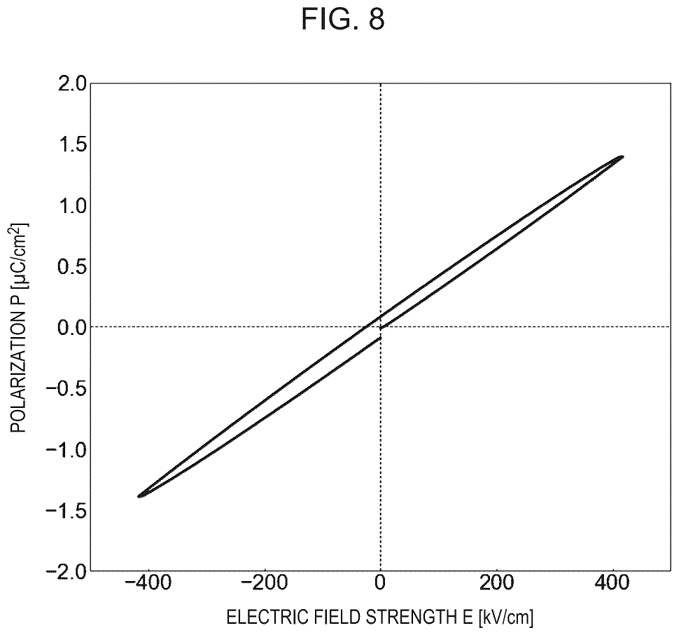

Using a ferroelectric tester Premier II manufactured by Radiant Technologies, Inc., a polarization-electric field (P-E) measurement was performed on the capacitor of Example 1 to obtain a P-E curve for the capacitor. Dielectric properties of the capacitor of Example 1 were evaluated based on the P-E curve. FIG. 8 is a graph (P-E curve) showing the relationship between polarization and electric field strength in the capacitor of Example 1. In FIG. 8, the ordinate axis represents polarization, and the abscissa axis represents electric field strength. The withstand voltage of the capacitor of Example 1 was determined by the maximum value of the electric field strength in the P-E curve. The withstand voltage of the capacitor of Example 1 was 418 kV/cm, and the maximum polarization was 1.39 μC/cm². The results are shown in Table 1.

### Example 2

A coating solution according to Example 2 was obtained in the same manner as in Example 1 except that 0.375 mmol of NH₄Br, 0.75 mmol of PbBr₂, 0.125 mmol of NH₄Cl, and 0.25 mmol of PbCl₂ were added to 1 ml of the mixed solvent of DMSO and DMF. A capacitor according to Example 2 was produced in the same manner as in Example 1 except for using the coating solution of Example 2 instead of the coating solution of Example 1. The composition of the dielectric material contained in the dielectric layer of the capacitor of Example 2 was determined based on XRD measurement and XPS measurement in the same manner as in Example 1. The crystal structure of the dielectric material contained in the dielectric layer of the capacitor of Example 2 was determined based on XRD measurement in the same manner as in Example 1. In the same manner as in Example 1, a P-E curve for the capacitor of Example 2 was obtained, and the withstand voltage and the maximum polarization were determined. The results are shown in Table 1.

### Example 3

A coating solution according to Example 3 was obtained in the same manner as in Example 1 except that 0.25 mmol of NH₄Br, 0.5 mmol of PbBr₂, 0.25 mmol of NH₄Cl, and 0.5 mmol of PbCl₂ were added to 1 ml of the mixed solvent of DMSO and DMF. A capacitor according to Example 3 was produced in the same manner as in Example 1 except for using the coating solution of Example 3 instead of the coating solution of Example 1. The composition of the dielectric material contained in the dielectric layer of the capacitor of Example 3 was determined based on XRD measurement and XPS measurement in the same manner as in Example 1. The crystal structure of the dielectric material contained in the dielectric layer of the capacitor of Example 3 was determined based on XRD measurement in the same manner as in Example 1. In the same manner as in Example 1, a P-E curve for the capacitor of Example 3 was obtained, and the withstand voltage and the maximum polarization were determined. The results are shown in Table 1.

### Example 4

A coating solution according to Example 4 was obtained in the same manner as in Example 1 except that 0.5 mmol of NH₄Cl and 1 mmol of PbCl₂ were added to 1 ml of the mixed solvent of DMSO and DMF. A capacitor according to Example 4 was produced in the same manner as in Example 1 except for using the coating solution of Example 4 instead of the coating solution of Example 1. The composition of the dielectric material contained in the dielectric layer of the capacitor of Example 4 was determined based on XRD measurement and XPS measurement in the same manner as in Example 1. The crystal structure of the dielectric material contained in the dielectric layer of the capacitor of Example 4 was determined based on XRD measurement in the same manner as in Example 1. In the same manner as in Example 1, a P-E curve for the capacitor of Example 4 was obtained, and the withstand voltage and the maximum polarization were determined. The results are shown in Table 1.

### Example 5

A coating solution according to Example 5 was obtained in the same manner as in Example 1 except that 0.45 mmol of NH₄Br, 0.05 mmol of CH₃NH₃Br, and 1 mmol of PbBr₂ were added to 1 ml of the mixed solvent of DMSO and DMF. A capacitor according to Example 5 was produced in the same manner as in Example 1 except for using the coating solution of Example 5 instead of the coating solution of Example 1. The composition of the dielectric material contained in the dielectric layer of the capacitor of Example 5 was determined based on XRD measurement and XPS measurement in the same manner as in Example 1. The crystal structure of the dielectric material contained in the dielectric layer of the capacitor of Example 5 was determined based on XRD measurement in the same manner as in Example 1. In the same manner as in Example 1, a P-E curve for the capacitor of Example 5 was obtained, and the withstand voltage and the maximum polarization were determined. The results are shown in Table 1.

### Example 6

A coating solution according to Example 6 was obtained in the same manner as in Example 1 except that 0.45 mmol of NH₄Br, 0.05 mmol of HC(NH₂)₂Br, and 1 mmol of PbBr₂ were added to 1 ml of the mixed solvent of DMSO and DMF. HC(NH₂)₂Br is a salt comprising NH₂CH═NH₂⁺ as a cation. A capacitor according to Example 6 was produced in the same manner as in Example 1 except for using the coating solution of Example 6 instead of the coating solution of Example 1. The composition of the dielectric material contained in the dielectric layer of the capacitor of Example 6 was determined based on XRD measurement and XPS measurement in the same manner as in Example 1. The crystal structure of the dielectric material contained in the dielectric layer of the capacitor of Example 6 was determined based on XRD measurement in the same manner as in Example 1. In the same manner as in Example 1, a P-E curve for the capacitor of Example 6 was obtained, and the withstand voltage and the maximum polarization were determined. The results are shown in Table 1.

### Comparative Example 1

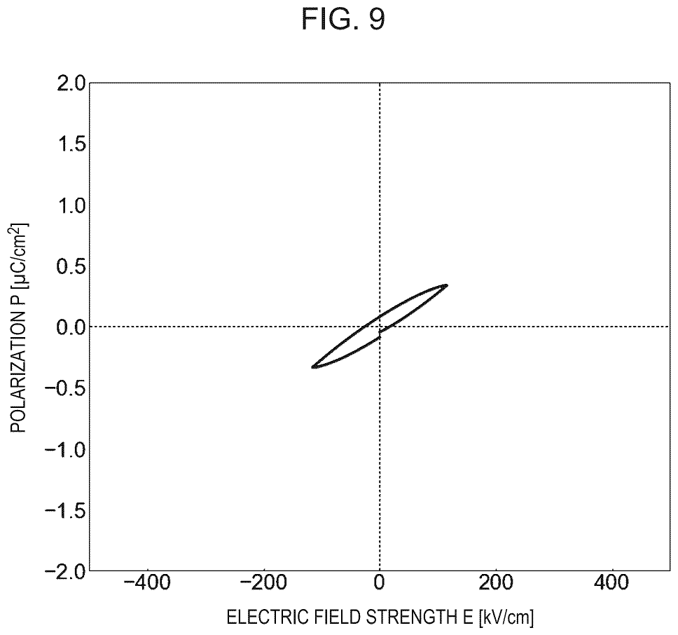

A coating solution according to Comparative Example 1 was obtained in the same manner as in Example 1 except that 0.5 mmol of KBr and 1 mmol of PbBr₂ were added to 1 ml of the mixed solvent of DMSO and DMF. A capacitor according to Comparative Example 1 was produced in the same manner as in Example 1 except for using the coating solution of Comparative Example 1 instead of the coating solution of Example 1. The composition of the dielectric material contained in the dielectric layer of the capacitor of Comparative Example 1 was determined based on XRD measurement and XPS measurement in the same manner as in Example 1. The crystal structure of the dielectric material contained in the dielectric layer of the capacitor of Comparative Example 1 was determined based on XRD measurement in the same manner as in Example 1. In the same manner as in Example 1, a P-E curve for the capacitor of Comparative Example 1 was obtained, and the withstand voltage and the maximum polarization were determined. The results are shown in Table 1. FIG. 9 is a graph (P-E curve) showing the relationship between polarization and electric field strength in the capacitor of Comparative Example 1. In FIG. 9, the ordinate axis represents polarization, and the abscissa axis represents electric field strength.

### Comparative Example 2

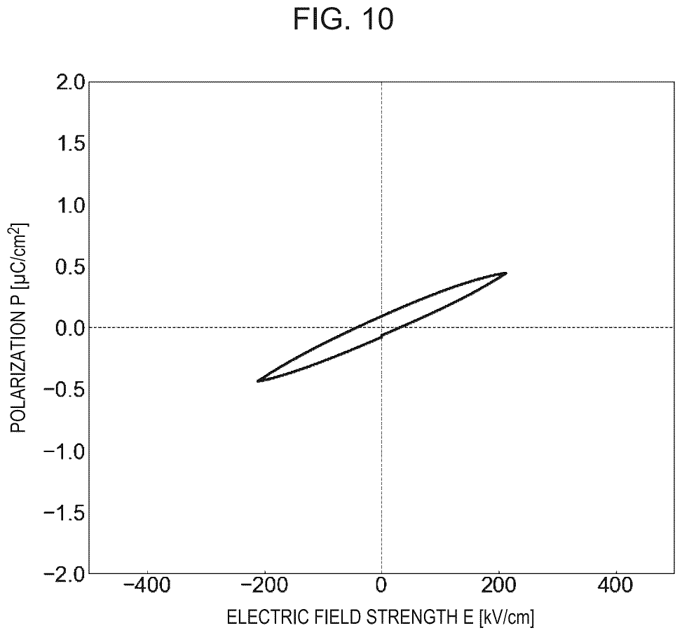

A coating solution according to Comparative Example 2 was obtained in the same manner as in Example 1 except that 0.5 mmol of CsBr and 1 mmol of PbBr₂ were added to 1 ml of the mixed solvent of DMSO and DMF. A capacitor according to Comparative Example 2 was produced in the same manner as in Example 1 except for using the coating solution of Comparative Example 2 instead of the coating solution of Example 1. The composition of the dielectric material contained in the dielectric layer of the capacitor of Comparative Example 2 was determined based on XRD measurement and XPS measurement in the same manner as in Example 1. The crystal structure of the dielectric material contained in the dielectric layer of the capacitor of Comparative Example 2 was determined based on XRD measurement in the same manner as in Example 1. In the same manner as in Example 1, a P-E curve for the capacitor of Comparative Example 2 was obtained, and the withstand voltage and the maximum polarization were determined. The results are shown in Table 1. FIG. 10 is a graph (P-E curve) showing the relationship between polarization and electric field strength in the capacitor of Comparative Example 2. In FIG. 10, the ordinate axis represents polarization, and the abscissa axis represents electric field strength.

As shown in Table 1, the dielectric materials contained in the dielectric layers of the capacitors of Examples 1 to 6 each comprise a lead ion as a metal cation, and a cation which is a molecular ion containing a nitrogen atom(s). As can be appreciated by a comparison of the Examples with Comparative Examples 1 and 2, the inclusion of a molecular ion containing a nitrogen atom(s) is likely to provide a capacitor having an increased withstand voltage. Further, because of increased withstand voltage, the capacitors of the Examples have an increased maximum polarization.

TABLE 1

| | | | Withstand | Max. |
|---|---|---|---|---|
| | | | voltage of | polarization of |
| | | | capacitor | capacitor |
| | | Presence/absence | (measured | (measured |
| | | of nitrogen- | value) | value) |
| | Composition | containing cation | (kV/cm) | (μC/cm²) |
| Ex. 1 | (NH₄)Pb₂Br₅ | Present | 418 | 1.39 |
| Ex. 2 | (NH₄)Pb₂Cl_{1.25}Br_{3.75} | Present | 350 | 1.23 |
| Ex. 3 | (NH₄)Pb₂Cl_{2.5}Br_{2.5} | Present | 300 | 1.54 |
| Ex. 4 | (NH₄)Pb₂Cl₅ | Present | 267 | 1.58 |
| Ex. 5 | (NH₄)_{0.9}(CH₃NH₃)_{0.1}-Pb₂Br₅ | Present | 320 | 1.00 |
| Ex. 6 | (NH₄)_{0.9}(HC(NH₂)₂)_{0.1}-Pb₂Br₅ | Present | 230 | 0.70 |
| Comp. Ex. 1 | KPb₂Br₅ | Absent | 116 | 0.338 |
| Comp. Ex. 2 | CsPb₂Br₅ | Absent | 213 | 0.439 |

The capacitor according to the present disclosure is likely to have a high withstand voltage and is therefore useful.

What is claimed is:

1. A capacitor comprising:
a first electrode;
a second electrode; and
a dielectric disposed between the first electrode and the second electrode,
wherein the dielectric comprises a crystal having a composition represented by APb₂X₅, where
A is a cation which is a molecular ion containing at least one nitrogen atom, and
X is a halogen element.

2. The capacitor according to claim 1, wherein the cation further contains at least one carbon atom.

3. The capacitor according to claim 1, wherein the cation is an ammonium ion represented by the following formula: 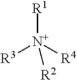
where R¹, R², R³, and R⁴ are each independently a hydrogen atom, an alkyl group, an aryl group, or NH₂.

4. The capacitor according to claim 3, wherein in the formula, R¹ and R² are each independently a hydrogen atom, an alkyl group, or an aryl group, and R³ and R⁴ are each a hydrogen atom.

5. The capacitor according to claim 4, wherein in the formula, R¹, R², R³, and R⁴ are each a hydrogen atom.

6. The capacitor according to claim 3, wherein in the formula, R¹ is NH₂ and R², R³, and R⁴ are each a hydrogen atom.

7. The capacitor according to claim 1, wherein the dielectric has an anti-perovskite structure.

8. An electric circuit comprising the capacitor according to claim 1.

9. A circuit board comprising the capacitor according to claim 1.

10. A device comprising the capacitor according to claim 1.
